(19) United States
(12) Patent Application Publication
(10) Pub. No.: US 2009/0319359 A1
(43) Pub. Date: Dec. 24, 2009

(54) Social behavioral targeting based on influence in a social network

(75) Inventors: Harry Raymond Soza, San Jose, CA (US); Mark Wayman, Oakland, CA (US); Stephen J. Brown, Woodside, CA (US)

Correspondence Address: LUMEN PATENT FIRM, 350 Cambridge, Suite 100, PALO ALTO, CA, 94306, US

(73) Assignee: vyrl mkt, Inc.

(21) Appl. No.: 12/288,614

(22) Filed: Oct. 21, 2008

Related U.S. Application Data
(60) Provisional application No. 61/132,481, filed on Jun. 18, 2008.

(51) Int. Cl. G06Q 30/00

(52) U.S. Cl. 705/14.25; 705/14.44; 705/14.49

(57) ABSTRACT

Behavioral targeting to push promotional offers to members of a social network is provided. The selection and redemption of promotional offers can increase by providing members of a social network with relevant and high value offers. In addition, marketing campaigns can increase their effectiveness with knowledge and identification of members having a high degree of influence on other members. A member's measure of influence is determined by characterizations of the member's friends based on monitored actions of the friends. In other words, relevant promotional offers can be targeted to a consumer based indirectly on the actions of the friends of the consumer in addition to the direct behavior of the consumer himself. The actions and behavior of a consumer and his or her friends can be tracked within the social network setting. Pushing relevant and high value offers enables rapid and viral spread of offers.

### CROSS-REFERENCE TO RELATED APPLICATIONS

This application claims priority from U.S. Provisional Patent Application 61/132,481 filed Jun. 18, 2008, which is incorporated herein by reference.

### FIELD OF THE INVENTION

The invention relates generally to behavioral targeting. More particularly, the present invention relates to pushing promotional offers based on behavioral targeting in a social network.

### BACKGROUND

Commercial enterprises rely on marketing campaigns to attract consumers to their products, build consumer rapport, and obtain consumer information for future business decisions. Traditional marketing campaigns typically include advertisements, promotions, and coupons directed to a wide audience in hopes that many members of the audience will use the promotions. However, many marketing campaigns are unsuccessful as potential consumers view the promotions merely as unwanted nuisances. In addition, potential consumers receiving offers often naturally distrust the source of the promotional offers. Gaining this trust is a difficult hurdle for marketers.

Recently, marketing campaigns employ electronic media to distribute electronic coupons. However, the use of electronic media typically mimics techniques of traditional campaigns, such as by placing banner advertisements in an Internet-based format, resulting in the same difficulties and failures as the more traditional marketing campaigns. For example, an electronic coupon can be offered to a potential customer by sending an unsolicited electronic mail to the customer or an electronic coupon can be posted as an advertisement on a webpage. For these example coupon-offering schema, consumers are often hesitant to use the unsolicited coupons and even those seeking coupons would have difficulties finding the appropriate and trustworthy webpage.

Computer-implemented social networks, such as MySpace.com and Facebook.com, are becoming increasingly popular. Social networks generically include a plurality of members, each of whom has a group of friends who are also members of the social network. Though social networks are extremely popular, especially by young consumers, manufacturers and businesses have had very limited success with marketing to potential consumers through the social networks. Existing marketing campaigns for social networks typically also mimic traditional advertising and promotional campaigns, such as through the use of online banner ads. Importantly, existing promotional campaigns do not appreciate or use the existing relationship information between a member of a social network and his or her friends.

The present invention addresses at least the difficult problems of distributing promotional offers and advances the art with a method and system for pushing promotional offers in a social network.

### SUMMARY OF THE INVENTION

The present invention is directed to a method and a system for pushing promotional offers based on behavioral targeting in a social network. In a particular embodiment, the present invention is directed to a method of pushing promotional offers to a member of a computer-implemented social network based on behavior of friends of the member. The method includes monitoring one or more actions of multiple friends of the member of the social network. The monitored actions are used to characterize the friends of the member with respect to one or more domains. A measure of influence of the member with respect to one or more domains is determined at least partially based on the characterizations of the friends of the member. One or more promotional offers are pushed to the member based on the measure of influence of the member. The promotional offers are also associated with one or more domains and the pushed promotional offer is selected based, at least in part, on the domain of the pushed promotional offer.

The monitored actions of the friends of the member include an acceptance of promotional offers, a referral of promotional offers, a redemption of promotional offers, a frequency of receiving promotional offers, a frequency of referring promotional offers, a stated interest of promotional offers, a stated interest, or any combination thereof. The promotional offers are directed to a product or a service of one or more sponsors, and can include a discount, a coupon, an advertisement, a voucher, an incentive to purchase, a ticket, an access pass, or any combination thereof.

In a preferred embodiment, the value of the promotional offer pushed to the member is determined based at least partially on the measure of influence of the member. In another embodiment, a refer function is provided to allow the member to refer the pushed promotional offer to friends of the member and the value of the pushed promotional offer is determined at least partially on a number of referrals by the member. In yet another embodiment, the promotional offer pushed to the member includes an identifier associated with one of the friends of said member, wherein the identifier includes text, an audio clip, a visual graphic, an audio-visual clip, or any combination thereof, associated with the friend of the member.

In an embodiment, the behavior of a member is tracked, wherein the measure of influence of the same member is at least partially based on the tracked behavior. It is noted that in certain embodiments, the relationship between a member and the friends of the member is bidirectional, wherein the member can refer offers to and receive offers from a friend.

In a preferred embodiment, the method includes providing a survey to the member, wherein the survey is related to an interest of said member, an interest of said friends of said member, a usage pattern of said member, a usage pattern of one or more of said friends of said member, or any combination thereof. The survey can be used to determine a relevant domain for the member. Another promotional offer is selected and pushed to the member, wherein the selection is based on the relevant domain.

The present invention is also directed to a system for measuring influence and pushing promotional offers to members of a social network. The system includes a computer-implemented social network of a plurality of members, wherein each of the members of the social network has one or more friends. The system also includes a monitor function and a characterize function for monitoring actions of the friends and characterizing the friends with respect to one or more domains based on the monitored actions, respectively. An influence function is provided for determining a measure of influence of the members of the social network with respect to one or more domains. The measure of influence is determined at least partially based on the characterization of the friends of the members. The system also includes an offer function for pushing one or more promotional offers to be received by at least one of the members, wherein the pushed the promotional offers are based on the measure of influence of the receiving members and the domains associated with the pushed promotional offers.

### BRIEF DESCRIPTION OF THE FIGURES

The present invention together with its objectives and advantages will be understood by reading the following description in conjunction with the drawings, in which:

FIG. 1 shows an example of pushing promotional offers to a member of a social network having a plurality of friends according to the present invention.

FIG. 2 shows an example of pushing offers belonging to domains A, B to a member with friends characterized as being associated with domains A, B according to the present invention.

FIG. 3 shows an example of characterizing friend F₁ of member M based on referrals of offers between friend F₁ and another member M′ according to the present invention.

FIG. 4 shows an example of using a member's friends as a filter to determine the member's measure of influence with respect to various domains according to the present invention.

FIG. 5 shows a flowchart of an example method of pushing promotional offers according to the present invention.

FIG. 6 shows a flowchart of an example method of pushing promotional offers and determining the value of the pushed offers based on a measure of influence according to the present invention.

FIG. 7 shows an example offer application display on a social network according to the present invention.

FIG. 8 shows examples of offers that include identifiers of friends according to the present invention.

FIG. 9 shows an example offer application display for sharing or referring offers to friends in a social network according to the present invention.

FIG. 10 shows an example offer application display for inviting friends to join the offer application according to the present invention.

FIGS. 11A-B show an example of providing a survey to be completed by a member of a social network and pushing offers based on the completed survey according to the present invention.

FIG. 12 shows an example of a survey to be completed by a member to allow the member to receive improved offers according to the present invention.

FIG. 13 shows an example offer distribution system according to the present invention.

### DETAILED DESCRIPTION OF THE INVENTION

Effectively marketing products and services through promotional offers can be a daunting task. An effective marketing campaign must be able to reach a large number of potential consumers and provide them with relevant offers that they will be interested in receiving and redeeming. Furthermore, for offers that can be referred, a marketing campaign can increase its effectiveness by identifying consumers who have a great deal of influence over other consumers. The present invention is directed to obtaining information to identify influential users and to provide relevant offers to those users.

The present invention is directed at using inherent characteristics of social networks for effective behavioral targeting to push promotional offers. A computer-implemented social network comprises a plurality of members, who are communicatively connected through a communication network, such as the Internet. Generally, information related to each member is stored by the social network application, some of which is accessible by other members and applications. The information relating to members of a social network can include stated interests of the members. Importantly, each member has one, a few, or many friends, who are often also members of the social network, themselves. However, a member's friend is not necessarily a member of the social network. Oftentimes, a member has a pre-existing relationship with one or more of his or her friends in addition to a relationship through referral or sharing of offers.

The present invention is directed to behavioral targeting based on relationships and interactions between a member of a social network and his or her friends for pushing promotional offers. By monitoring actions of members and their friends, influential members can be identified and relevant offers can be provided to them.

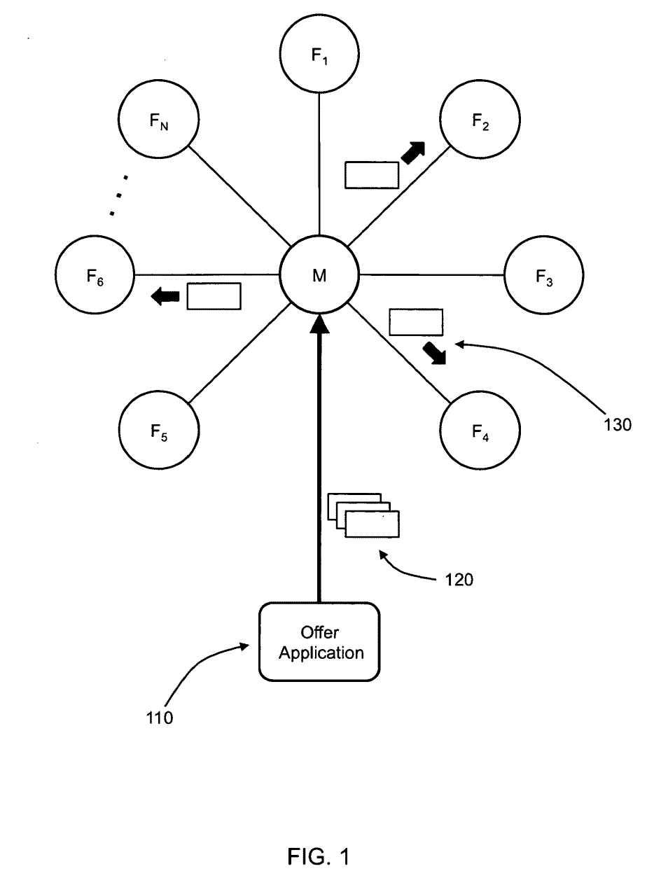

FIG. 1 shows a member M of a computer-implemented social network and the member's friends F₁-F_{N}, whom member M is connected with through the social network. Member M receives promotional offers 120 through an offer application 110. The offer application 110 can be a computer application downloadable and usable on the social network or can be any application for pushing promotional offers 120 that is accessible by member M. A promotional offer 120 includes, but is not limited to, a discount, a coupon, an advertisement, a voucher, an incentive to purchase, a ticket, an access pass, or any combination thereof. After receiving the offers 120 from the offer application 110, member M can redeem one or more of the promotional offers or refer the offers 130 to friends F₁-F_{N} of member M.

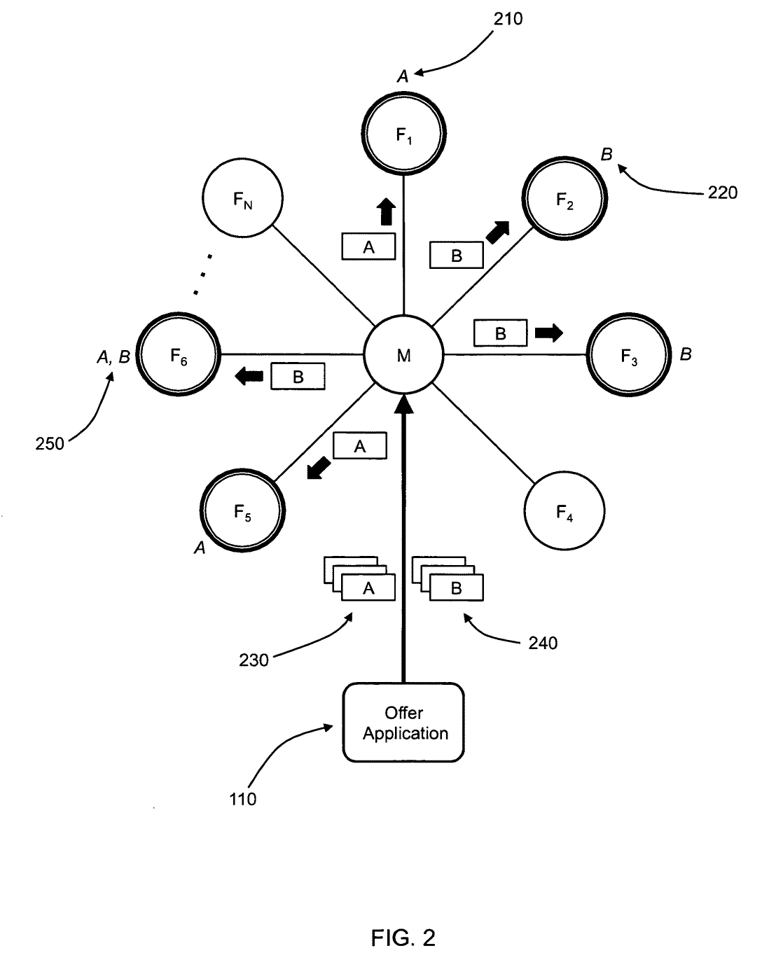

FIG. 2 shows a detailed embodiment of the present invention, in which some of the friends F₁-F_{N} of member M have been characterized and offers 230, 240 are pushed to member M based on the characterization of the friends F₁-F_{N}. In particular, the friends F₁-F_{N} of member M are characterized with respect to one or more domains. For example, friends F₁ and F₅ are characterized as being associated with domain A, whereas friends F₂ and F₃ are characterized as being associated with domain B. A friend can also be characterized as being associated with multiple domains, e.g. friend F₆ is characterized as being associated with domains A and B. The domains can include any category that may be relevant for marketing purposes, including demographic categories, socio-economic categories, and interests, such as sports, entertainment, science, home, garden, camping, education, college, baby, etc.

A measure of influence of member M with respect to one or more domains can be determined at least partially based on the characterization of friends F₁-F_{N} of member M with respect to the same domains. The measure of influence of a member is used to determine which offers or domain of offers to push to the member. In FIG. 2, since member M has friends characterized as being associated with domains A and B, member M has a high measure of influence for those domains. Therefore, promotional offers 230 and 240 related to domains A and B, respectively, will be pushed to member M. The promotional offers 230 and 240 can be redeemed by member M or shared with the friends F₁-F_{N} of member M.

It is important to note that promotional offers associated with a specific domain can be pushed to member M, even if member M has no stated interest in that domain. In other words, member M can have a high measure of influence for receiving offers in a domain due to the characterizations of the friends F₁-F_{N} of member M and irrespective of the interests of member M himself or herself. For example, a member having multiple friends who are characterized as being interested in golf will have a high measure of influence for a golf domain. The offer application 110 will preferentially push promotional offers related to golf to the member even if the member himself has no interest in golf.

The friends F₁-F_{N} of member M are characterized based on one or more monitored actions of the friends F₁-F_{N}. Monitored actions of a friend include, but are not limited to, an acceptance of promotional offers, a referral of promotional offers, a redemption of promotional offers, a frequency of receiving promotional offers, a frequency of referring promotional offers, a stated interest of promotional offers, a stated interest, or any combination thereof.

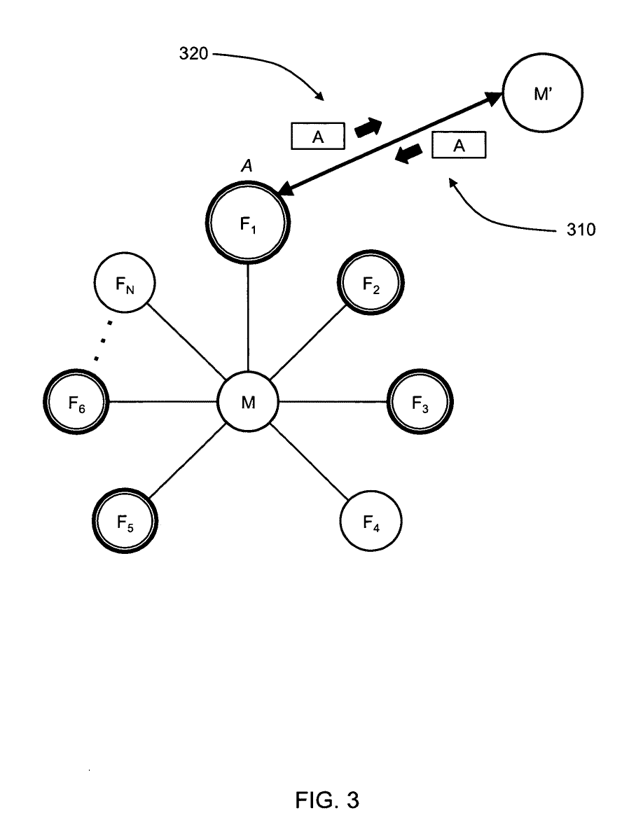

For example, FIG. 3 shows actions of friend F₁ of member M being monitored to characterize friend F₁ as being associated with domain A. The actions can include receiving a promotional offer 310 from another member M′ or referring a promotional offer 320 to member M′. The received or referred promotional offers are associated with domain A, therefore friend F₁ is characterized as having an interest in domain A. This characterization of friend F₁ affects the measure of influence of member M with respect to domain A. It is noted that the relationship between a member and a friend of the member is bidirectional, in that a member can refer offers to the friend and receive offers referred by the friend, similar to the relationship between member M′ and friend F₁. Records of the monitored actions of the friends can be maintained, such as in a database. In an embodiment, the monitored record includes an identifier of each of said monitored friends.

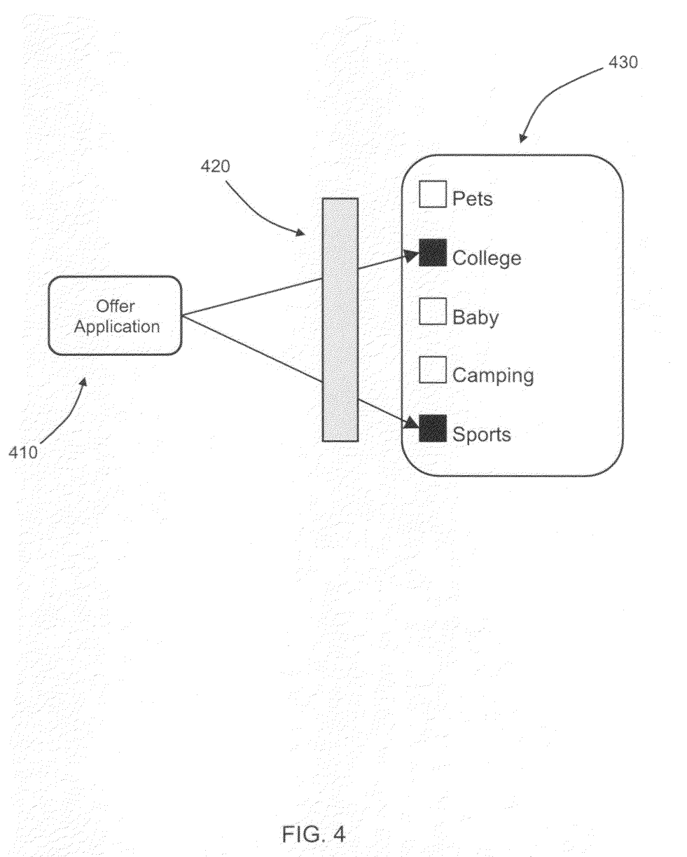

By monitoring the actions of friends of a member and characterizing the friends with respect to a domain, the community of friends of a member acts as a filter for the offer application to distribute relevant promotional offers to the member. FIG. 4 shows how a community of friends 420 of member 430 acts as a filter between the offer application 410 and member 430. In the example shown in FIG. 4, the community of friends 420 filters out the less relevant domains and enables the offer application to direct promotional offers only in the relevant domains of college and sports to member 430.

In an embodiment, the behavior or actions of a member can also be tracked. The tracked behavior of the member, along with the characterization of the friends of the member, can be used to determine the measure of influence of the member. The actions of the member to be tracked can be similar to the monitored actions of the friends, such as the referral of offers from the member to the friends of the member.

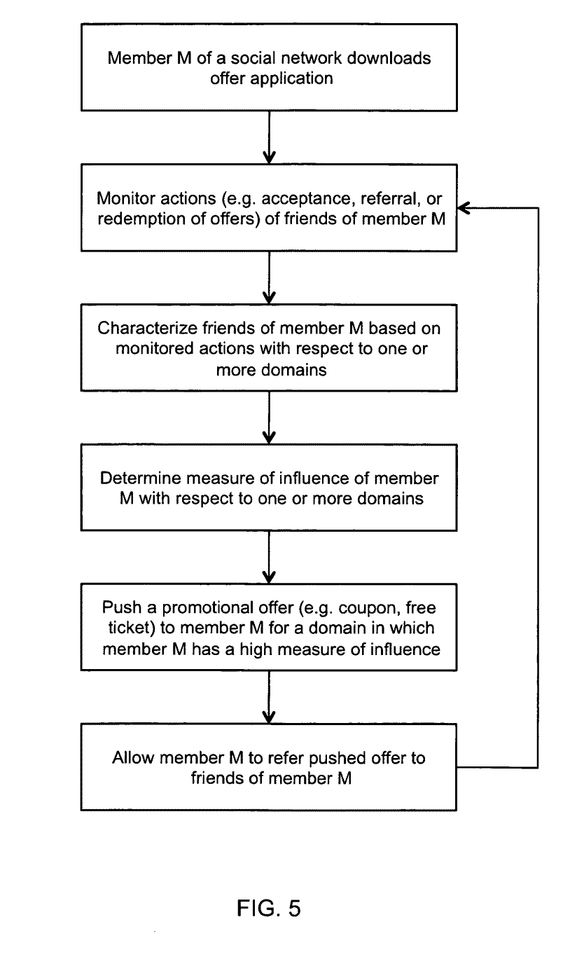

FIG. 5 shows a flowchart of an example method of pushing promotional offers based on a measure of influence. It is important to note that the measure of influence of a member is updatable. In an embodiment, the measure of influence of a member can be changed due to changes to the characterization of one or more friends, characterization of additional friends, actions done by the member, or additional monitored actions by one or more friends. Updating the measure of influence of a member with respect to domains allows for more effective selection of promotional offers to be pushed to the member.

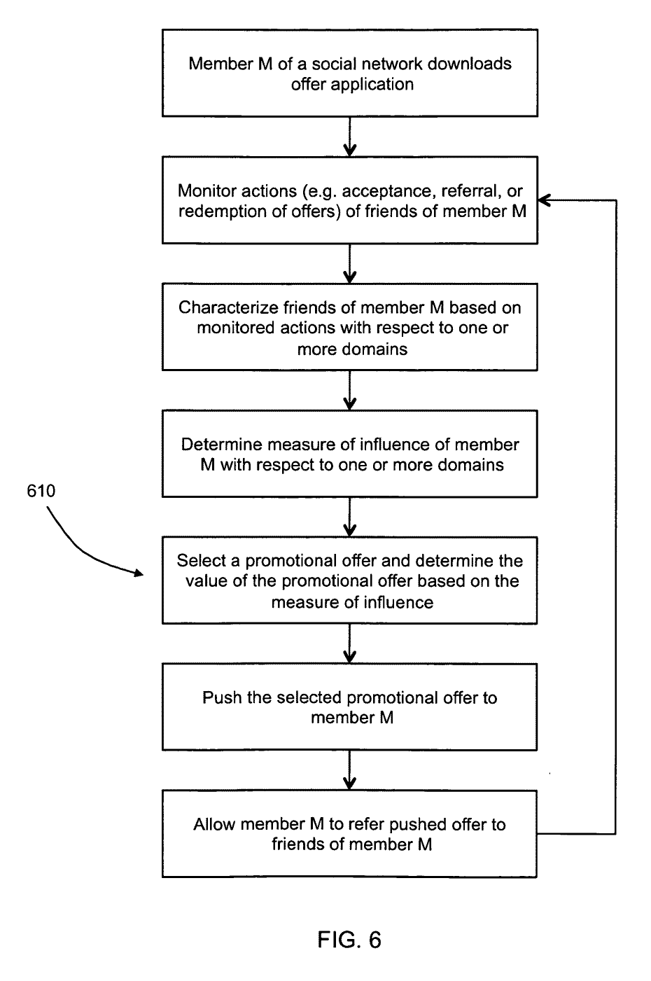

FIG. 6 shows a flowchart similar to the flowchart of FIG. 5. In the embodiment shown in FIG. 6, the value of the promotional offer is dependent on the measure of influence of the member. In a preferred embodiment, a promotional offer pushed to members with high measures of influence has greater value than a similar promotional offer pushed to members with low measures of influence. By having promotional offer values depend on the measure influence, members can be awarded for being influential.

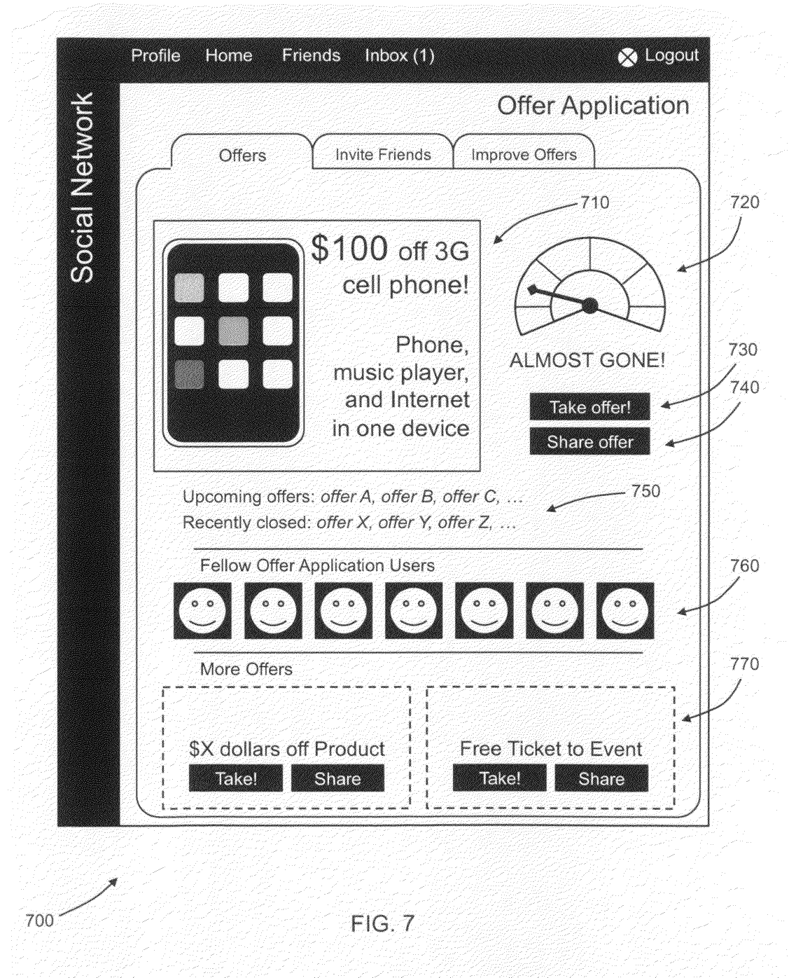

FIG. 7 shows an example graphical user interface (GUI) 700, such as a website, for the offer application. As can be appreciated by one of ordinary skill in the art, the offer application can be created for use in a platform provided by computer-implemented social networks. In an embodiment, the offer application GUI 700 is accessible by a member through a web browser, and preferably, after the member logs into a social networking website. In an embodiment, the offer application must be downloaded by members of a social network to receiving offers directly from the application.

The offer application GUI 700 includes an offer 710 pushed to a member of the social network. In an embodiment, the availability 720 of the offer 710 is displayed. Preferably, offers having high value have more limited availability than low value offers. A member can take the offer 730 or share the offer 740 with other members and/or to friends of the member.

In the embodiment shown in FIG. 7, upcoming and past offers 750 are also displayed. In addition, the GUI 700 shows other members 760 who are also users of the offer application. Any number of offers can be displayed by the offer application, including offers 770.

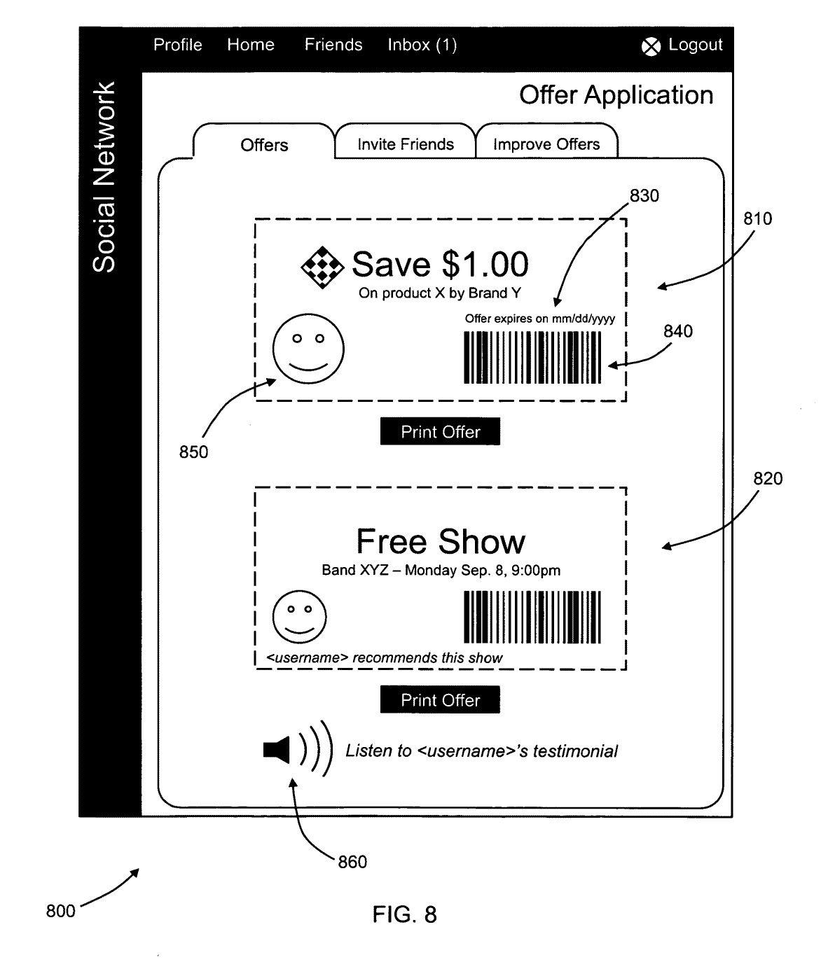

By taking or accepting an offer, a member is allowed to print or otherwise redeem the offer for the product or service indicated by the offer. An example first offer 810 to be printed is shown in FIG. 8. The first offer 810 is a discount coupon for product. The coupon can be redeemed at a retail store, an online retailer, or any other location that accepts the coupon. The first offer 810 can also include an expiration date 830 and a bar code 840. The bar code 840 enables redemption data to be tracked. In an embodiment, the bar code 840 includes personalized information related to the member receiving the first offer. FIG. 8 also shows an example second offer 820 for a free admissions ticket to a musical event.

In an embodiment, a pushed promotional offer includes an identifier or testimonial by another member of the social network. For example, first offer 810 includes a picture 850 of a friend of the member receiving the offer. Other identifiers, including name or usernames can be incorporated on the offers. In another embodiment, the identifier includes a media, audio, or audio-visual clip 860 of another member of the social network. The media clip can include a testimonial relating to the product, service, or event displayed on the offer 820. By having an identifier of a friend or another member of the social network, offer referrals are more likely to be trusted by the receiving member.

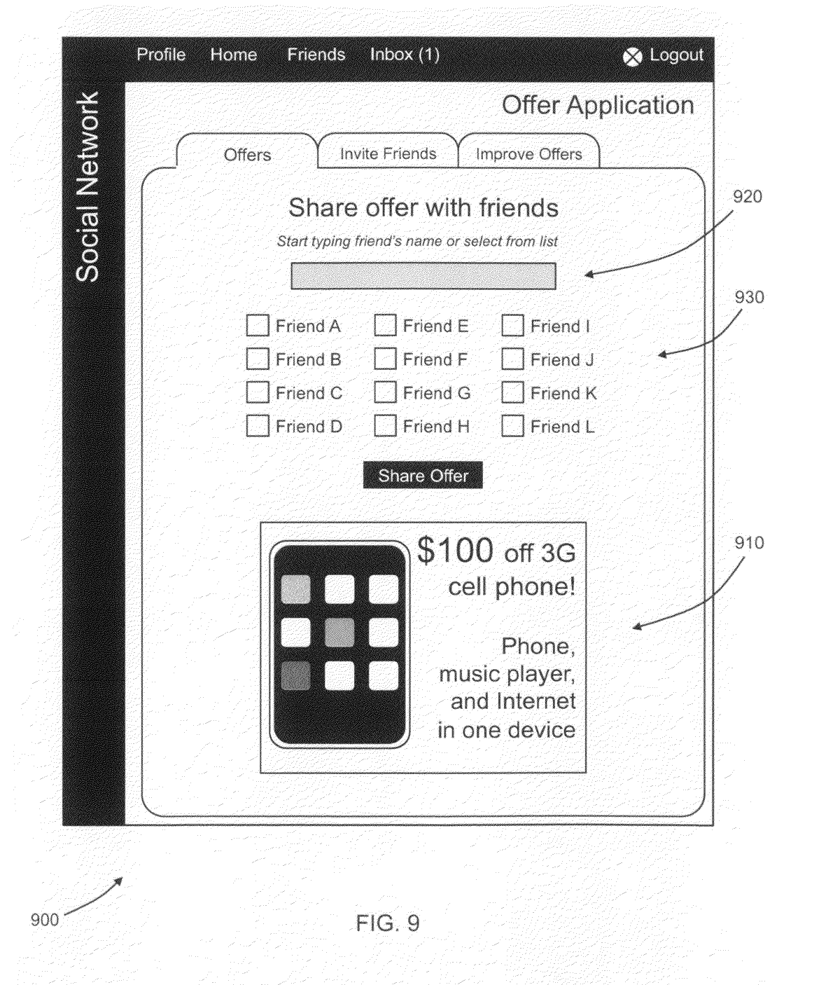

In a preferred embodiment, a member of a social network who has received one or more promotional offers can share the offers to friends of the member. FIG. 9 shows a website GUI 900 for sharing or referring an offer 910 to friends. Referred friends can be entered 920 or selected from a list 930. By allowing offers to be shared, the promotional offers can spread rapidly and virally, particularly in a social network setting. In an embodiment, the value of the offer 910 can be changed based on the number of referrals made by the member. For example, an offer of $10 off of a product can be increased to $50 off if a member refers the offer to 10 of his or her friends. In an embodiment, the condition for increasing the value of the offer based on the number of referrals can be indicated to the member. Alternatively, the increase in value can be done automatically without alerting the member.

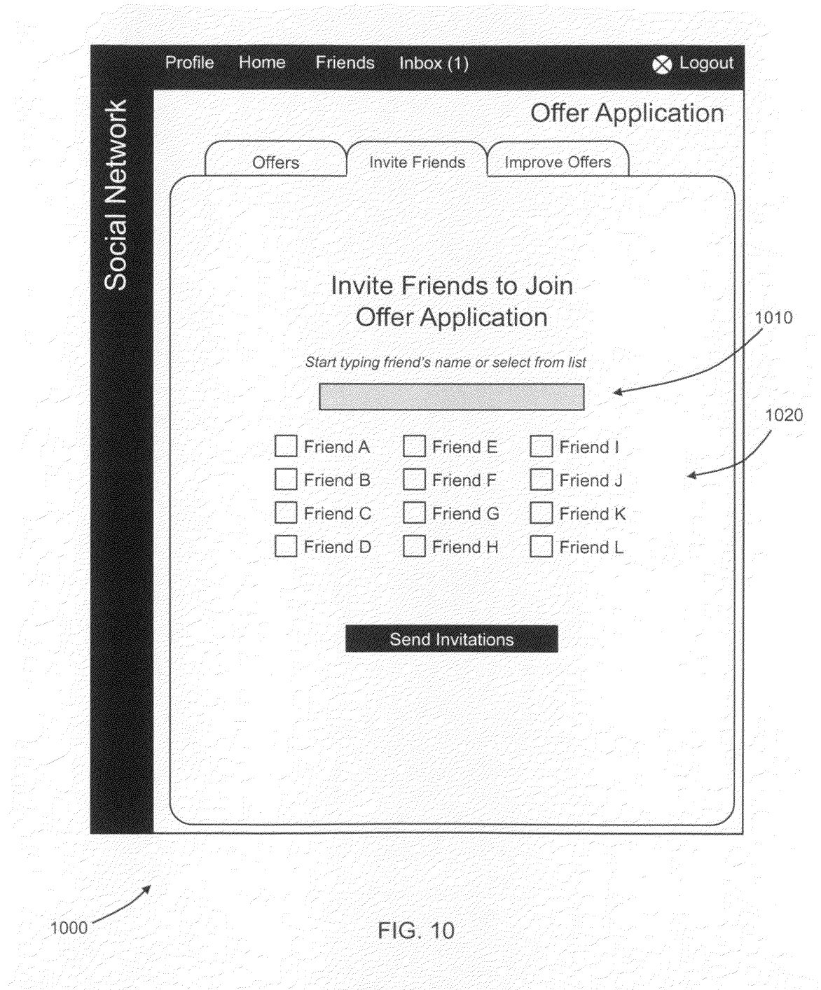

FIG. 10 shows a display 1000 of an invitation function for a member to invite his or her friends to join the offer application. The friends can be entered 1010 or selected from a list 1020. In an embodiment, the measure of influence of the inviting member and/or a value of a promotional offer can change based on a number of invitations. Similar to the offers themselves, the sharing or inviting to join the offer application enables a rapid and viral spread of the offer application.

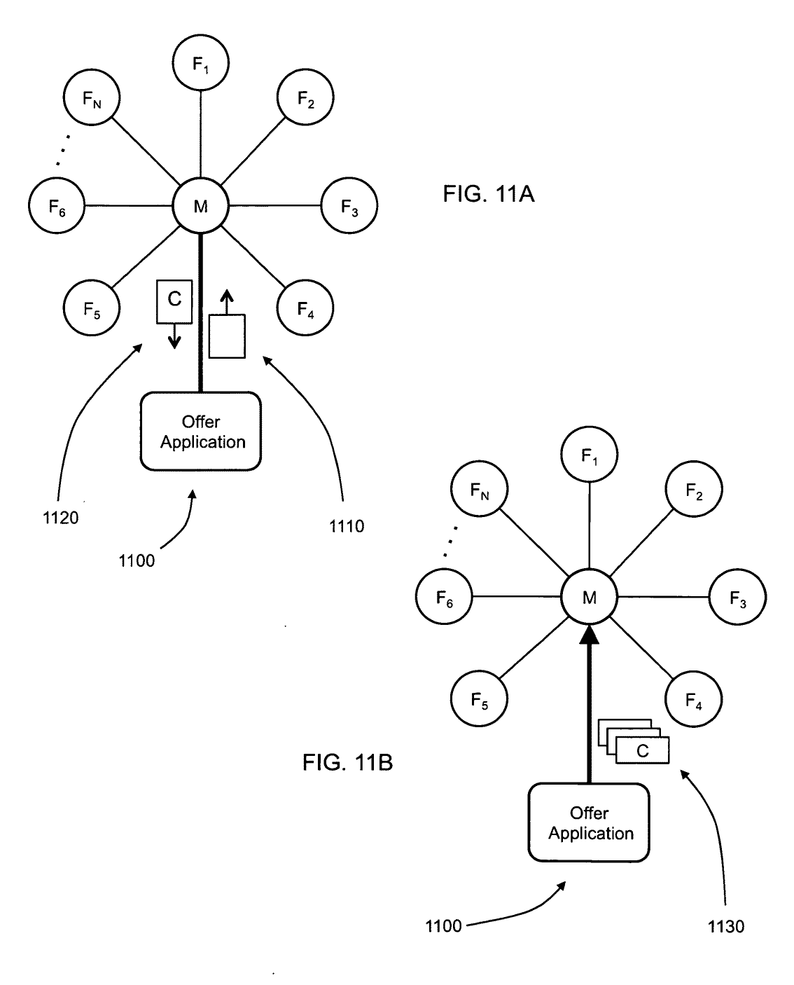

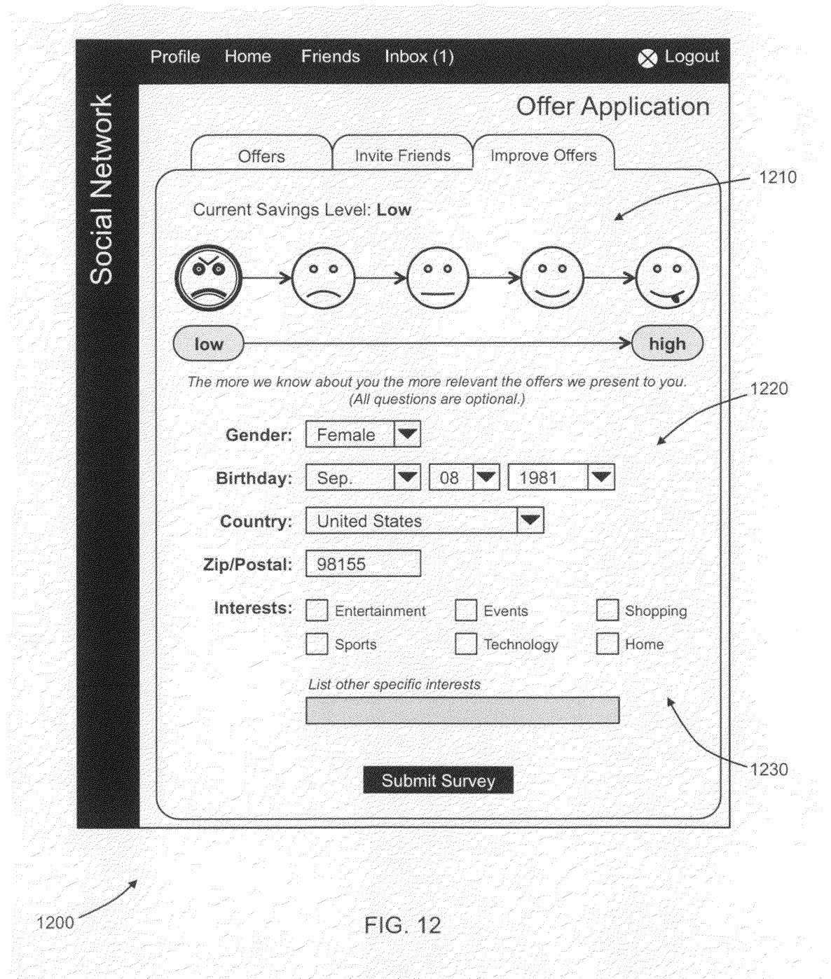

FIGS. 11-12 show embodiments of the present invention related to surveys transmitted to a member of the social network. FIG. 11A shows a survey 1110 sent from the offer application 1100 to member M. The survey can be related to information about the member, interests of the member, interests of friends of the member, a usage pattern of the member, a usage pattern of one or more friends of the member, or any combination thereof. Member M completes and submits the survey 1120 to the offer application 1100. The completed survey 1120 can be used to determine a relevant domain to the member. For the example in FIG. 11A, the completed survey 1120 indicates that domain C is relevant to member M. One or more promotional offers associated with the relevant domain can be selected and pushed to the member. FIG. 11B shows promotional offers 1130 associated with domain C being pushed to member M.

Surveys can be used to increase the relevancy and the value of the pushed promotional offers. FIG. 12 shows an example of a survey 1200 for improving the value and relevancy of the offer. By completing the survey, a member can increase his or her savings level 1210, thereby the member can receive higher value offers. Surveys can include personal information, such as demographic information 1220 and/or information relating to interests 1230 of the member.

It is important to note that, as described above, a member's measure of influence and/or the values of promotional offers are updatable through actions of the member, actions of the friends of the member, or both. The actions that can lead to changes of the measure of influence and/or the value of promotional offers include, but are not limited to, referral of offers between two or more members of a social network, invitations to join or download the offer application, and submissions of completed surveys by members of the social network. It is also important to note that a member's measure of influence can change indirectly through actions of the member's community without the member having to act at all. By having updatable measures of influence, the relevancy of promotional offers pushed to the member can be improved. Furthermore, member usage and referral of pushed offers will, presumably improve with more relevant and higher value offers.

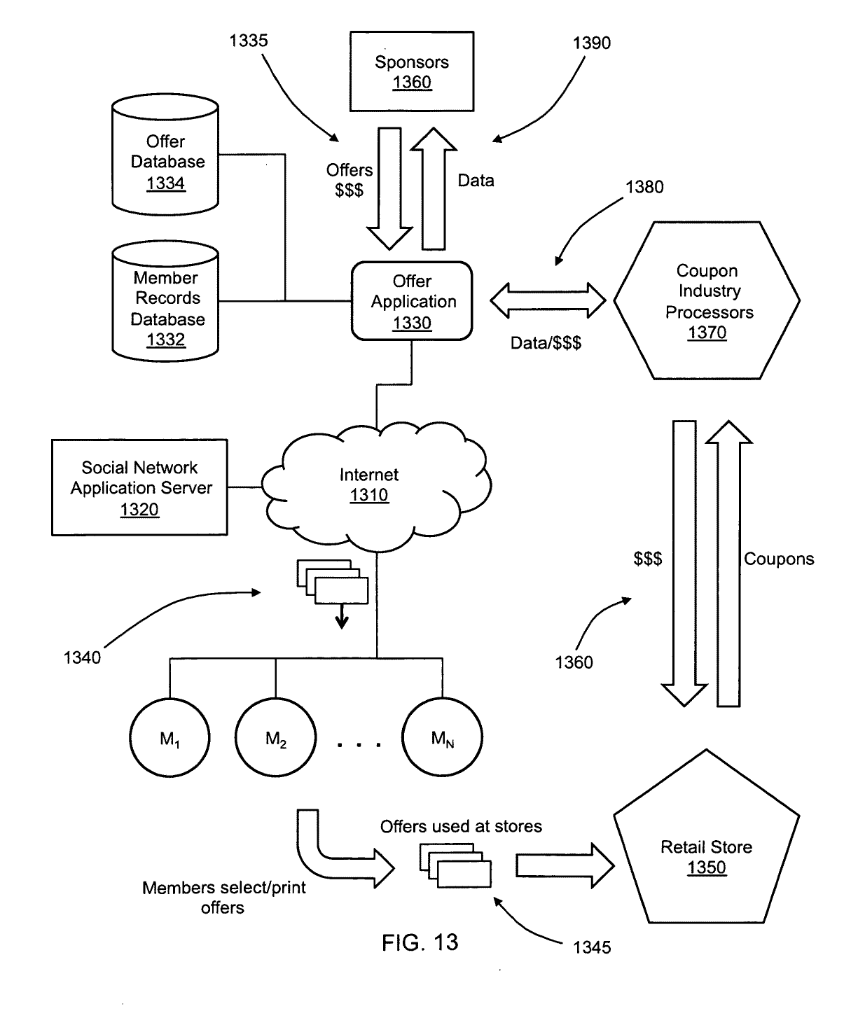

FIG. 13 shows an example offer distribution system including an offer application 1330 according to the present invention. The offer application 1330 receives offers 1335 from sponsors 1360, such as companies, commercial enterprises, individuals, stores, manufacturers, universities, or any other entity wishing to distribute promotional offers. The offers can be stored in an offer database 1334.

The offer application 1330 can be accessed through a communication network, such as the Internet 1310. Preferably, members M₁-M_{N} of a social network access the offer application through a social network webpage operated by a social network application server 1320. The offer application 1330 distributes offers 1340 to the members M₁-M_{N}, who can select and print the offers 1345. The printed offers can be used and redeemed at retail stores 1350. Alternatively or additionally, offers can include tickets or access passes for use at an event. In another embodiment, the offers 1340 are electronic offers to be used in an online environment instead of or in addition to a physical environment. Information relating to the selection or referral of offers is stored in a member records database 1332. FIG. 13 shows two separate databases for the offer database 1334 and the member records database 1332, however any number of databases can be used.

In the embodiment shown in FIG. 13, the redeemed offers or redemption information are transmitted to coupon industry processors 1370, such as redemption agents. Financial considerations are transferred 1360 between the coupon processors 1370 and the retail stores 1350. The redemption process between retail outlets 1350 and coupon processors 1370 is known in the art.

The redemption data and financial considerations 1380 are exchanged between coupon industry processors 1370 and the offer application 1330. The redemption data is used by the offer application 1330 to update member records in the offer member records database 1332. As described above, redemption data can be used to update members' measures of influence and used by the offer application 1330 to improve the relevancy and value of the offers 1340 pushed to the members M₁-M_{N}. In an embodiment, information relating to the members, such as offer selection data, offer referral data, and redemption data, can be transmitted 1390 to the sponsors 1360 for marketing or other purposes of the sponsors 1360.

As one of ordinary skill in the art will appreciate, various changes, substitutions, and alterations could be made or otherwise implemented without departing from the principles of the present invention, e.g. the Internet can be replaced by any network, such as a WAN or LAN, and any type of offer for products, services, or events can be provided by the offer application. Accordingly, the scope of the invention should be determined by the following claims and their legal equivalents.

What is claimed is:

1. A method of pushing promotional offers to a member of a computer-implemented social network based on behavior of friends of said member, said method comprising:
(a) monitoring one or more actions of multiple friends of said member of said computer-implemented social network, wherein each of said friends of said member has a pre-existing relationship with said member;
(b) characterizing at least one of said friends of said member based on said one or more monitored actions of said friends, wherein said characterizing is with respect to one or more domains;
(c) determining a measure of influence of said member with respect to one or more of said domains, wherein said measure of influence is at least partially based on said characterizing of said friends of said member;
(d) having a plurality of promotional offers, wherein each of said promotional offers is associated with one or more of said domains; and
(e) pushing at least one of said promotional offers to said member based on said measure of influence of said member and said domain associated with said pushed promotional offer.

2. The method as set forth in claim 1, wherein said monitored actions of said friends of said member comprises an acceptance of promotional offers, a referral of promotional offers, a redemption of promotional offers, a frequency of receiving promotional offers, a frequency of referring promotional offers, a stated interest of promotional offers, a stated interest, or any combination thereof.

3. The method as set forth in claim 1, further comprising determining a value of said promotional offer pushed to said member, wherein said value determining is based at least partially on said measure of influence of said member.

4. The method as set forth in claim 1, further comprising providing a refer function for allowing said member to refer said pushed promotional offer to said friends of said member.

5. The method as set forth in claim 4, further comprising determining a value of said promotional offer pushed to said member, wherein said value determining is based at least partially on a number of said referrals by said member.

6. The method as set forth in claim 1, further comprising maintaining a record of said friends of said member, wherein said record comprises an identifier for each of said friends and said monitored actions of each of said friends.

7. The method as set forth in claim 1, further comprising providing a survey to said member, wherein said survey is related to an interest of said member, an interest of said friends of said member, a usage pattern of said member, a usage pattern of one or more of said friends of said member, or any combination thereof.

8. The method as set forth in claim 7, further comprising:
(f) determining a relevant domain for said member based on said survey;
(g) selecting a second promotional offer to push to said member of said social network, wherein said selecting said second promotional offer is based on said relevant domain of said member; and
(h) pushing said second promotional offer to said member.

9. The method as set forth in claim 1, wherein said promotional offer pushed to said member includes an identifier associated with one of said friends of said member, and wherein said identifier comprises text, an audio clip, a visual graphic, an audio-visual clip, or any combination thereof.

10. The method as set forth in claim 1, wherein said promotional offers are directed to a product or a service of one or more sponsors, and wherein said plurality of promotional offers comprises a discount, a coupon, an advertisement, a voucher, an incentive to purchase, a ticket, an access pass, or any combination thereof.

11. The method as set forth in claim 1, further comprising tracking behavior of one of said members of said social network, wherein said measure of influence of the same of said members is at least partially based on said tracked behavior of the same of said members.

12. The method as set forth in claim 1, wherein said relationship between said member and each of said friends of said member is bidirectional, wherein said member can refer said promotional offers to said friends of said member, and wherein said member can receive said promotional offers referred by at least one of said friends of said member.

13. A system for measuring influence and pushing promotional offers, said system comprising:
(a) a computer-implemented social network of a plurality of members, wherein each of said members of said social network has one or more friends;
(b) a monitor function for monitoring actions of said friends of one or more of said members;
(c) a characterize function for characterizing at least one of said friends of one or more of said members based on said one or more monitored actions of said friends, wherein said characterizing is with respect to one or more domains;
(d) an influence function for determining a measure of influence of each of said members with said monitored friends, wherein said measure of influence is with respect to one or more of said domains, and wherein said measure of influence is at least partially based on said characterizing of said friends of the same of said members;
(e) a plurality of promotional offers, wherein each of said promotional offers is associated with one or more of said domains; and
(f) an offer function for pushing at least one of said promotional offers to be received by at least one of said members, wherein said pushed promotional offers are based on said measure of influence of each of said receiving members and said domains associated with said pushed promotional offers.

14. The system as set forth in claim 13, wherein said monitored actions of said friends of said member comprises an acceptance of promotional offers, a referral of promotional offers, a redemption of promotional offers, a frequency of receiving promotional offers, a frequency of referring promotional offers, a stated interest of promotional offers, a stated interest, or any combination thereof.

15. The system as set forth in claim 13, wherein a value of one of said promotional offers pushed to one of said members is based at least partially on said measure of influence of the same of said members.

16. The system as set forth in claim 13, further comprising a refer function for allowing one of said members to refer at least one of said pushed promotional offers to said friends of the same of said members.

17. The system as set forth in claim 13, further comprising a database for storing a record of said friends of each of said members, wherein said record comprises an identifier for each of said friends of the same of said members and said monitored actions of each of said friends of the same of said members.

18. The system as set forth in claim 13, further comprising a survey function for providing one or more surveys to some of said members of said computer-implemented social network, wherein said surveys are related to an interest of said member, an interest of said friends of said member, a usage pattern of said surveyed members, a usage pattern of one or more of said friends of said surveyed members, or any combination thereof.

19. The system as set forth in claim 18, wherein said offer function:
determines a relevant domain for said member based on said survey;
selects a second promotional offer to push to said member of said social network, wherein said selecting said second promotional offer is based on said relevant domain of said member; and
pushes said second promotional offer to said member.

20. The system as set forth in claim 13, wherein one of said promotional offers pushed to one of said members includes an identifier associated with one of said friends of the same of said members, and wherein said identifier comprises text, an audio clip, a visual graphic, an audio-visual clip, or any combination thereof.
